(19) United States
(12) Patent Application Publication
(10) Pub. No.: US 2019/0032990 A1
(43) Pub. Date: Jan. 31, 2019

(54) REFRIGERATOR APPLIANCES AND LOCKING ASSEMBLIES THEREFOR

(71) Applicant: Haier US Appliance Solutions, Inc., Wilmington, DE (US)

(72) Inventors: Louis A. Wantland, Louisville, KY (US); Bagawathkumar Chellappan, Prospect, KY (US); Brent Alden Junge, Evansville, IN (US)

(21) Appl. No.: 15/659,692

(22) Filed: Jul. 26, 2017

(51) Int. Cl. F25D 23/02; F25D 11/00; E05C 19/16; E05C 7/02

(52) U.S. Cl. CPC F25D 23/025; F25D 11/00; F25D 2323/021; E05C 7/02; F25D 2323/023; E05C 19/16

(57) ABSTRACT

A refrigerator appliance including a locking assembly is provided herein. The refrigerator appliance may include a cabinet defining a food storage chamber and one or more doors rotatably attached to the cabinet. A door may be movable between an open position distal to the food storage chamber and a closed position proximal to the food storage chamber. The locking assembly may selectively secure the door in the closed position. The locking assembly may include a first magnetic element attached to the cabinet apart from the door, a second magnetic element movably mounted within the door for selective magnetic engagement with the first magnetic element in the closed position, and an articulating arm. The second magnetic element may be movable between a first position and a second position within the door.

### FIELD OF THE INVENTION

The present subject matter relates generally to refrigerator appliances, and more particularly to refrigerator appliances having one or more doors and locking assemblies.

### BACKGROUND OF THE INVENTION

Refrigerator appliances generally include a cabinet that defines a food storage chamber. In addition, refrigerator appliances also generally include a door rotatably hinged to the cabinet to permit selective access to food items stored in the food storage chamber. Certain refrigerator appliances, commonly referred to as door-in-door refrigerator appliances, may also include an outer door rotatably hinged to the inner door to permit selective access to the food storage chamber or, alternatively, a food storage chamber positioned between the inner and outer doors. In addition, door-in-door appliances may also include a gasket positioned on the outer door. Thus, when the outer door is in the closed position, the gasket seals against the inner door to enclose the food storage chamber.

Door-in-door refrigerator appliances also generally include a locking mechanism that allows a user to lock the inner and outer door together. The locking mechanism generally includes a latch positioned on the outer door and a mating catch positioned on the inner door. In operation, the latch engages the catch to lock the outer door to the inner door. However, because of the air-tight or near air-tight seal effected when the outer door is in the closed position, the effect of a hard or even moderate slamming of the outer door is to compress the air within the cabinet, setting up a counter force tending to re-open the outer door. Moreover, many a seal between the inner door and the outer door may hold the two doors together, even when a user only wishes to open the outer door.

Accordingly, a refrigerator appliance having a locking assembly with features for assisting promoting opening/closing of the door would be useful. In particular, a refrigerator appliance having a door-in-door configuration with features for promoting closing and/or opening of the outer door would be especially useful.

### BRIEF DESCRIPTION OF THE INVENTION

Aspects and advantages of the invention will be set forth in part in the following description, or may be obvious from the description, or may be learned through practice of the invention.

In one aspect of the present disclosure, a refrigerator appliance is provided. The refrigerator appliance may include a cabinet defining a food storage chamber, a door, and a locking assembly. The door may be rotatably attached to the cabinet. The door may be movable between an open position distal to the food storage chamber and a closed position proximal to the food storage chamber. The locking assembly may selectively secure the door in the closed position. The locking assembly may include a first magnetic element attached to the cabinet apart from the door, a second magnetic element movably mounted within the door for selective magnetic engagement with the first magnetic element in the closed position, and an articulating arm. The second magnetic element may be movable between a first position and a second position within the door. The articulating arm may be coupled to the door in selective operative engagement with the second magnetic element to motivate the second magnetic element between the first position and the second position.

In another aspect of the present disclosure, a refrigerator appliance is provided. The refrigerator appliance may include a cabinet defining a food storage chamber, an inner door, and outer door, and a locking assembly. The inner door may be rotatably hinged to the cabinet. The inner door may be movable between an open position and a closed position to permit selective access to the food storage chamber. The outer door may be rotatably hinged to the inner door. The outer door may be movable between an open position and a closed position. The locking assembly may selectively secure the outer door in the closed position. The locking assembly may include a first magnetic element mounted within the inner door, a second magnetic element movably mounted within the outer door for selective magnetic engagement with the first magnetic element in the closed position of the outer door, and an articulating arm. The second magnetic element may be movable between a first position and a second position within the door. The articulating arm may be coupled to the outer door in selective operative engagement with the second magnetic element to motivate the second magnetic element between the first position and the second position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a refrigerator appliance according to exemplary embodiments of the present disclosure.

FIG. 2 provides a side view of the exemplary refrigerator appliance of FIG. 1.

FIG. 3 provides a perspective view of the exemplary refrigerator appliance of FIG. 1.

FIG. 4 provides a perspective view of a portion of a refrigerator appliance according to exemplary embodiments of the present disclosure.

FIG. 5 provides an enlarged view of a portion of FIG. 4.

FIG. 6 provides a side schematic view of a door of a refrigerator appliance in a first position according to exemplary embodiments of the present disclosure.

FIG. 7 provides a side schematic view of the exemplary door of FIG. 6 in a second position.

FIG. 8 provides a side schematic view of a door of a refrigerator appliance in a first position according to exemplary embodiments of the present disclosure.

FIG. 9 provides a side schematic view of the exemplary door of FIG. 9 in a second position.

FIG. 10 provides a side schematic view of a door of a refrigerator appliance in a first position according to exemplary embodiments of the present disclosure.

FIG. 11 provides a side schematic view of the exemplary door of FIG. 10 in a second position.

FIG. 12 provides a side schematic view of a door of a refrigerator appliance in a first position according to exemplary embodiments of the present disclosure.

FIG. 13 provides a side schematic view of the exemplary door of FIG. 12 in a second position.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component or position from another and are not intended to signify an absolute location or importance of the individual components. Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

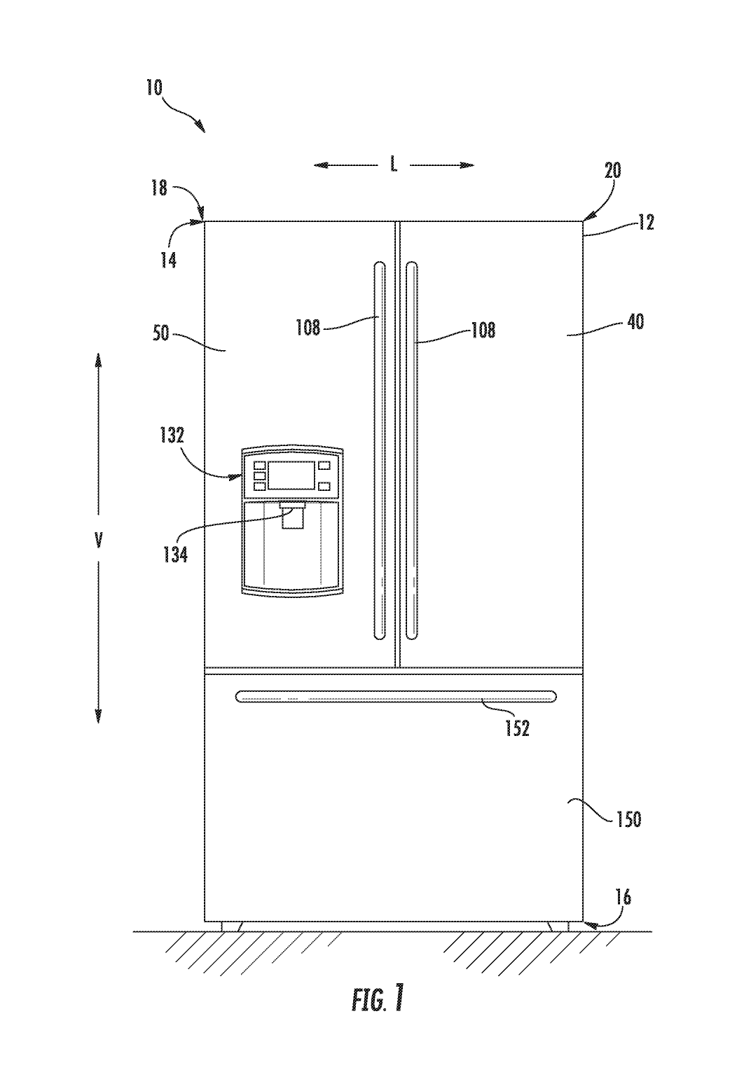

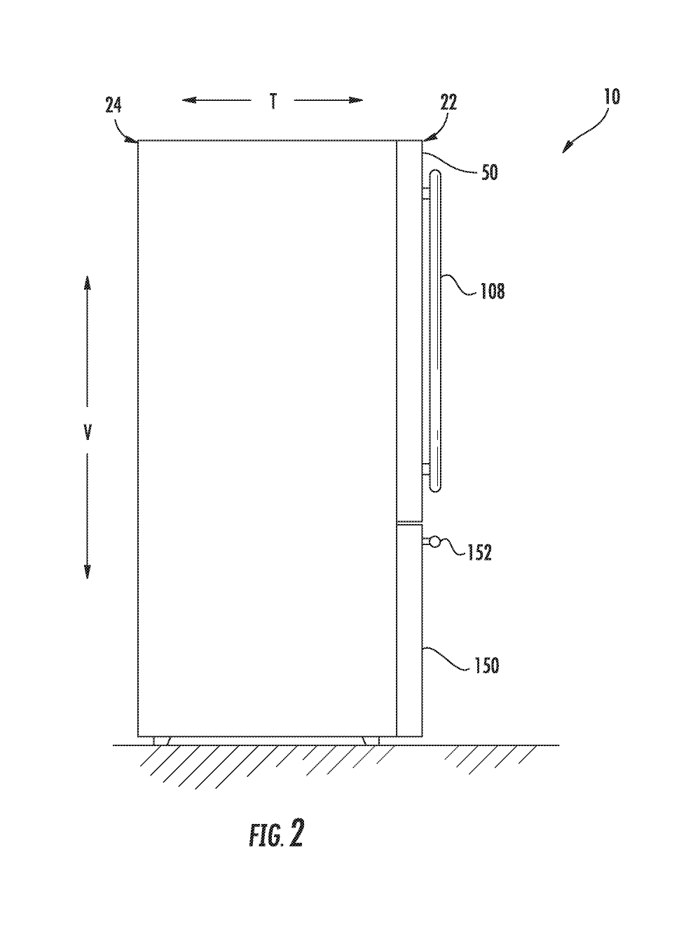

Referring now to FIGS. 1 through 3, a refrigerator appliance 10 according to an embodiment of the present subject matter defines a vertical direction V, a lateral direction L, and a transverse direction T (see, e.g., FIG. 2), each mutually perpendicular to one another. As may be seen, the refrigerator appliance 10 includes a housing or cabinet 12 that extends between a top 14 and a bottom 16 along the vertical direction V, between a left side 18 and a right side 20 along the lateral direction L, and between a front side 22 and a rear side 24 along the transverse direction T (see, e.g., FIG. 2).

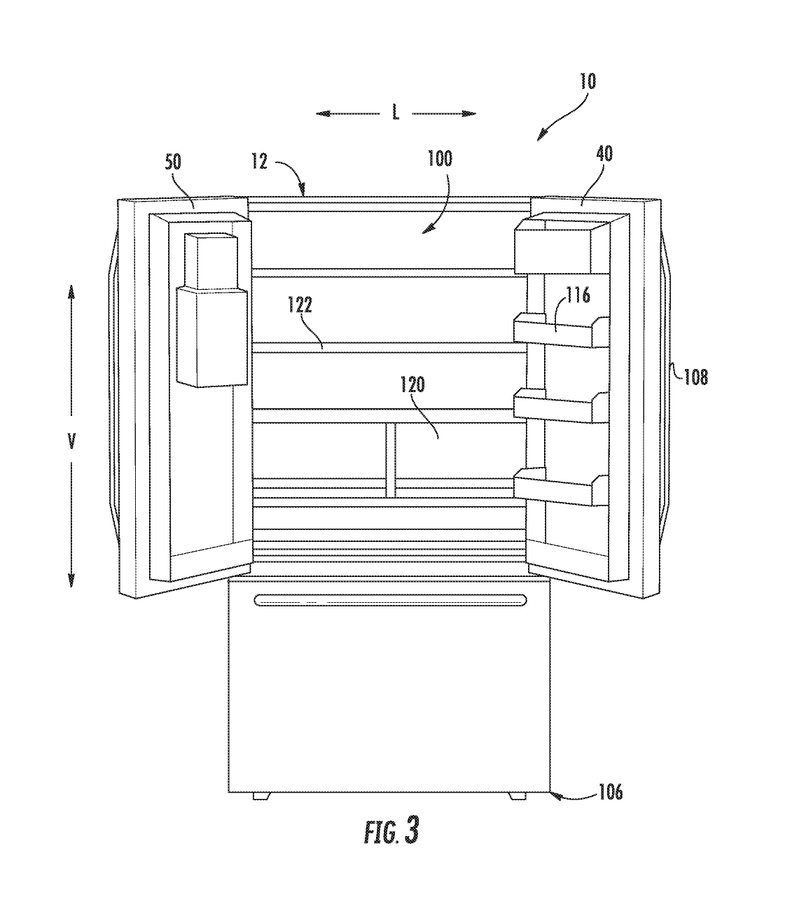

The cabinet 12 generally defines a food storage chamber 100 (FIG. 3) for receipt of food items for storage. In particular, the food storage chamber 100 is positioned at or adjacent the top 14 of the cabinet 12. It should be appreciated, however, that the food storage chamber 100 may be positioned at any suitable location within the refrigerator appliance 10. For example, in one embodiment, the food storage chamber 100 may extend from top 14 to bottom 16 along the vertical direction V.

The refrigerator appliance 10 may include one or more refrigerator doors 40, 50 rotatably mounted to the cabinet, e.g., such that the refrigerator doors 40, 50 permit selective access to the food storage chamber 100. As shown, in some embodiments, the refrigerator doors 40, 50 include a right refrigerator door 40 and a left refrigerator door 50. The right refrigerator door 40 may be rotatably mounted to the cabinet 12 at the right side 20 of the cabinet 12. The left refrigerator door 50 may be rotatably mounted to the left side 18 of the cabinet 12. A handle 108 may be positioned on each of the refrigerator doors 40, 50 to facilitate movement of the doors 40, 50 between a fully closed position (FIG. 1) and a fully open position (FIG. 3).

The refrigerator appliance 10 may also include a dispenser assembly 132 for dispensing liquid water and/or ice. The dispenser assembly 132 includes a dispenser 134 positioned on or mounted to an exterior portion of the refrigerator appliance 10, e.g., on the left refrigerator door 50. In addition, the refrigerator appliance 10 may include a freezer drawer 150 arranged below the refrigerator doors 40, 50 for selectively accessing items within a frozen food storage chamber (not shown). The freezer drawer 150 may include a handle 152 that is slidably mounted to the cabinet 12. Accordingly, the freezer drawer 150 may be moved in and out of the frozen food storage chamber (not shown) along the transverse direction T.

As shown in FIG. 3, various storage components may be mounted within the food storage chamber 100 to generally facilitate storage of food items. In certain embodiments, the storage components include bins 116, drawers 120, and shelves 122 that are mounted within the fresh food chamber 100. The bins 116, drawers 120, and shelves 122 are configured for receipt of food items (e.g., beverages and/or solid food items) and may assist with organizing such food items.

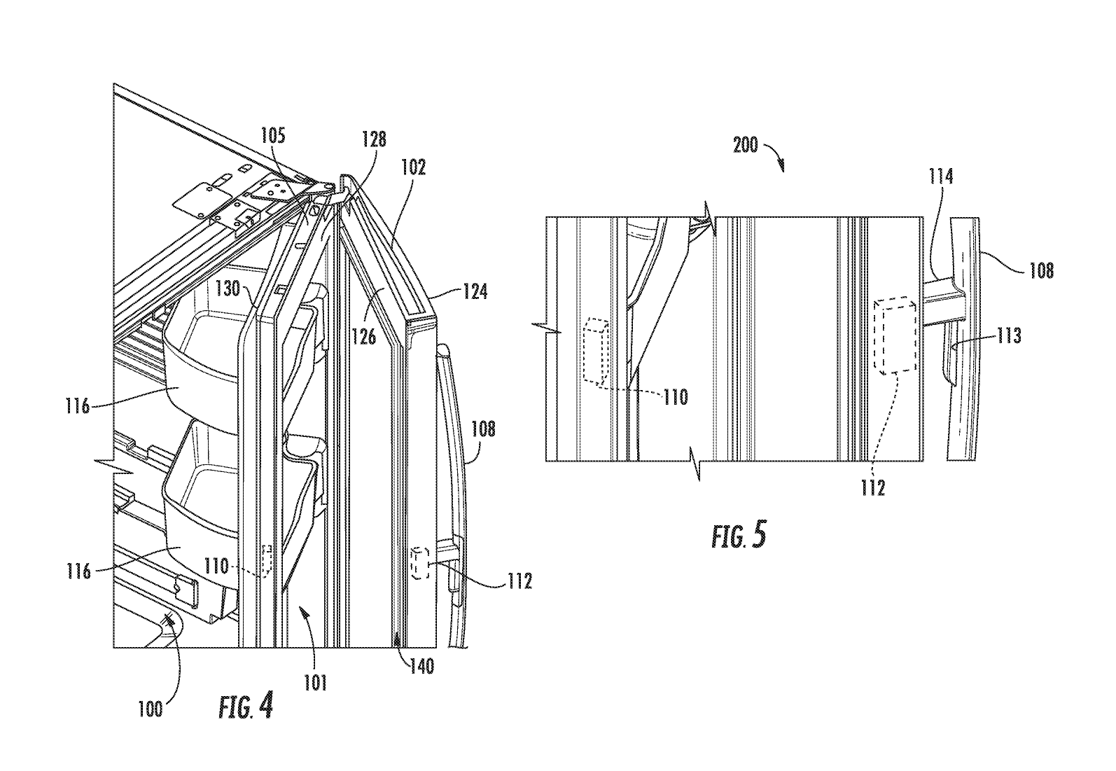

Referring now to FIGS. 4 and 5, the refrigerator appliance 10 may be configured as a door-in-door refrigerator. In particular, the right refrigerator door 40 may be replaced with a nested door assembly comprising an outer door 102 and an inner door 105. In another embodiment, the left refrigerator door 50 may be replaced with the nested door assembly. In yet another alternative embodiment, both refrigerator doors 40, 50 may be replaced with the nested door assembly.

The inner door 105 may include an outer surface 128 and an opposing inner surface 130, and the inner door 105 may be rotatably hinged to the cabinet 12, e.g., such that the inner door 105 is movable between a closed position (FIG. 1) and an open position (FIG. 4) to permit selective access to the food storage chamber 100 of the cabinet 12. In particular, the inner door 105 may be mounted to the cabinet 12 at the right side 20 of the cabinet 12. The inner door 105 may define an opening extending through the outer and inner surfaces 128, 130 and into the food storage chamber 100. Moreover, the inner door 105 may include a frame 106. As shown, the frame 106 may be positioned on the interior surface 130 of the inner door 105, and the frame 106 may extend around a perimeter of the opening defined by the inner door 105. Optionally, the frame 106 may extend into the fresh food storage chamber 100 when the inner door 105 is in the closed position.

The outer door 102 of the nested door assembly may include an outer surface 124 and an opposing inner surface 126. As shown, the outer door 102 may be rotatably hinged to the inner door 105, and the outer door 102 may be movable between a closed position (FIG. 1) and an open position (FIG. 4). In some embodiments, the outer door 102 is movable to permit selective access to a portion of the food storage chamber 100 through the opening defined by the inner door 105. In additional or alternative embodiments, a portion of the outer door 102 can be received within the frame 106 of the inner door 105 to define a second food storage chamber 101. In particular, the second food storage chamber 101 may be contiguous with the food storage chamber 100. It should be appreciated, however, that the second food storage chamber 101 may be isolated from the food storage chamber 100 in alternative embodiments. For example, the second storage chamber 101 may be a cavity defined in the outer surface 128 of the inner door 105. In particular, the cavity may not extend through the inner surface 130 of the inner door 105 and, as a result, may be isolated from the food storage chamber 100.

It should be appreciated that the outer and inner doors 102, 105 can generally move in the same direction. Specifically, the outer and inner doors 102, 105 may each move away from the food storage chamber 100 when moving towards their respective open positions or the fully open position. Moreover, the outer and inner doors 102, 105 may each move towards the food storage chamber 100 when moving towards their respective closed positions or the fully closed position.

In some embodiments, the refrigerator appliance 10 also includes a gasket 140 positioned on the inner surface 126 of the outer door 102. As the outer door 102 moves towards the closed position, the outer door 102 may compress the gasket 140 against the outer surface 128 of the inner door 105. Specifically, the gasket 140 may seal against the outer surface 128 of the inner door to enclose the food storage chamber 100 or, alternatively, the second food storage chamber 101. In alternative embodiments, the gasket 140 may be positioned on the outer surface 128 of the inner door 105 and, as the outer door 102 moves towards the closed position, the inner door 105 may compress the gasket 140 against the inner surface 126 of the outer door 102. More specifically, the gasket 140 may seal against the inner surface 126 of the outer door 102. It should be appreciated that the gasket 140 may be comprised of any suitable material. For example, in one embodiment, the gasket 140 may be comprised of a resilient rubber or plastic material.

The refrigerator appliance 10 includes a locking assembly 200 for holding one or more portions of doors 40 and/or 50 in a closed position. Specifically, locking assembly 200 includes a first magnetic element 110 and a second magnetic element 112 attached to cabinet 12 at separate locations to selectively couple (e.g., magnetically) engage with each other. In some such embodiments, locking assembly 200 is positioned to selectively lock the outer and inner doors 102, 105 together. As shown in FIGS. 4 and 5, the first magnetic element 110 may be provided on the inner door 105 while the second magnetic element 112 is provided on the outer door 102. In some embodiments, a handle 108 positioned on the outer door 102 includes a button or trigger 113 operably coupled (e.g., in mechanical or electrical communication) with the second magnetic element 112. Optionally, a trigger housing 114 may be mounted to the handle 108, and both the second magnetic element 112 and the trigger 113 may, at least in part, be positioned within the trigger housing 114.

In general terms, during use, a user may grasp the handle 108 of the outer door 102, pull the trigger 113 to release the second magnetic element 112 from the first magnetic element 110 and thereby unlock the outer door 102 from the inner door 105. When the outer door 102 is unlocked from the inner door 105, the outer door 102 may rotate independently of the inner door 105. As such, a user may access the bins 116 without opening the inner door 105. Alternatively, operating the handle 108 without pulling the trigger 113 permits opening the outer 102 and the inner door 105 together for full access to the food storage chamber 100.

Turning now to FIGS. 6 through 13 multiple embodiments of the locking assembly 200 are illustrated. As noted above, the locking assembly 200 includes the first and second magnetic elements 110, 112, which are generally attached to the cabinet 12 at different locations. In the door-in-door embodiments of FIGS. 6 through 13, the first magnetic element 110 is mounted within the inner door 105; the second magnetic element 112 is mounted within the outer door 102. It is understood that the first and second magnetic elements 110, 112 may be formed from any material that is suitably responsive to a magnetic field and/or capable of generating a magnetic field. In other words, the first and second magnetic elements 110, 112 are not formed from a purely diamagnetic material. The first and second magnetic elements 110, 112 may be formed from the same material or unique materials. As an example, the first magnetic element 110 may be one of a permanent magnet, ferromagnetic element, or electromagnetic element while the second magnetic element 112 is another of a permanent magnet, ferromagnetic element, or electromagnetic element. As another example, the first magnetic element 110 may be one of a permanent magnet, ferromagnetic element, or electromagnetic element while the second magnetic element 112 is the same of a permanent magnet, ferromagnetic element, or electromagnetic element.

In some embodiments, the second magnetic element 112 is movably mounted, e.g., within the outer door 102. In turn, the second magnetic element 112 may move within and relative to another portion the outer door 102 while remaining mounted therein. In the closed position of outer door 102, the second magnetic element 112 may move between a first position and a second position within the outer door 102. The first position may permit magnetic engagement between the first and second magnetic elements 110, 112. Optionally, the magnetic engagement may generate a magnetic pull force sufficient to hold the inner and outer door 102 together as both doors 105, 102 are opened. Advantageously, this force may be greater than would be permitted between the inner door 105 and the cabinet 12 itself (FIG. 1). The second position may move the magnetic element 112 such that the magnetic engagement is reduced or reversed, as will be described below.

In some embodiments, an articulating arm 213 is coupled to outer door 102. For instance, the articulating arm 213 may be operatively coupled (e.g., mechanically or electrically coupled) to trigger 113. In certain embodiments, the articulating arm 213 is formed as an extension of trigger 113. Articulating arm 213 may further extend through trigger housing 114 (FIG. 4). Moreover, the articulating arm 213 may be disposed in selective operative engagement (e.g., direct contact or mechanical engagement) with the second magnetic element 112 to motivate the second element between the first and second positions.

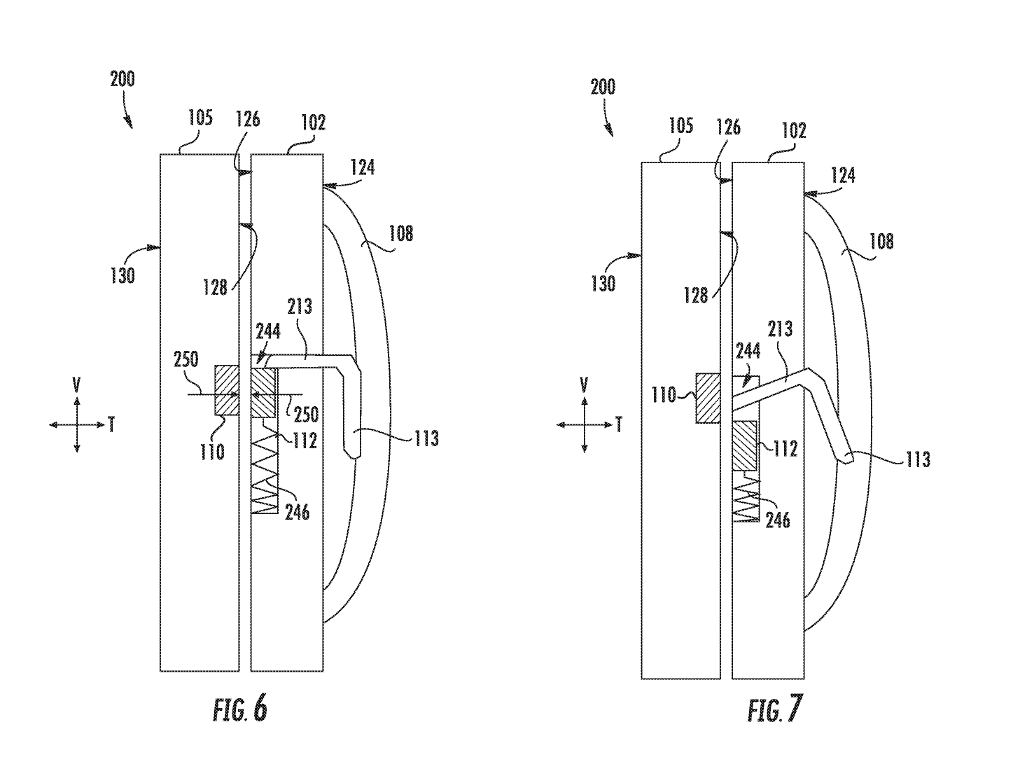

Turning specifically to FIGS. 6 and 7, in some embodiments, locking assembly 200 includes a first magnetic element 110 fixedly mounted within the inner door 105 between an inner surface 130 and an outer surface 128. A second magnetic element 112 is movably (e.g., slidably) mounted within the outer door 102 between an inner surface 126 and an outer surface 124. When both doors 105, 102 are provided in their respective closed positions, the first and second magnetic elements 110, 112 are thus spaced apart along the transverse direction T.

Optionally, one of the first and second magnetic elements 110, 112 may be a permanent magnet, while the other of the first and second magnetic elements 110, 112 is a ferromagnetic material (e.g., iron, nickel, cobalt, etc.). Alternatively, both the first and second magnetic elements 110, 112 may be permanent magnets.

In the embodiments of FIGS. 6 and 7, the second magnetic element 112 is slidably mounted within outer door 102 between an inner surface 126 and an outer surface 124. As shown, the second magnetic element 112 is enclosed within an internal passage 244. When assembled, the second magnetic element 112 may slide such that the second magnetic element 112 can translate along the vertical direction V between a first position (FIG. 6) and a second position (FIG. 7).

As shown, in the first position, the first magnetic element 110 and the second magnetic element 112 may be aligned in magnetic engagement. For instance, the first and second magnetic elements 110, 112 may be generally aligned along a horizontal (i.e., perpendicular to the vertical direction V) plane. In other words, the first and second magnetic elements 110, 112 are horizontally aligned at the same vertical height. A magnetic pull force (indicated at arrows 250) may be formed by the magnetic engagement between the first and second magnetic elements 110, 112. Optionally, the magnetic pull force 250 may be greater than 15 pounds. In alternative embodiments, such as a magnetic pull force directly between (e.g., coupling) a door and a refrigerator cabinet, the magnetic pull force may be less than 15 pounds.

By contrast, in the second position, the first magnetic element 110 and the second magnetic element 112 may be offset along the vertical direction V. In other words, the first magnetic element 110 and the second magnetic element 112 may be positioned at discrete horizontal planes. For instance, the second magnetic element 112 may be completely below the first magnetic element 110 in the second position, as illustrated in FIG. 7. In the second position, negligible magnetic engagement may exist between the first and second magnetic elements 110, 112 (e.g., less than one pound of force). Generally, this is understood to be less than a force holding the inner door 105 to cabinet 12 (FIG. 1). Advantageously, the locking assembly 200 may thus permit the outer door 102 to be readily separated from the inner door 105.

A biasing mechanism 246, such as an elastic or resilient spring, may be provided in some such embodiments. For instance, the biasing mechanism 246 may be mounted below the second magnetic element 112 (e.g., within the internal passage 244) to generally motivate or bias the second magnetic element 112 toward the first position.

In some embodiments, the articulating arm 213 and the trigger 113 are pivotally mounted to the handle 108. Moreover, the articulating arm 213 may contact the second magnetic element 112 (e.g., as the trigger 113 is engaged or pivoted). As the trigger 113 is pivoted, the articulating arm 213 may thus force or motivate the second magnetic element 112 downward, away from the first position and toward the second position.

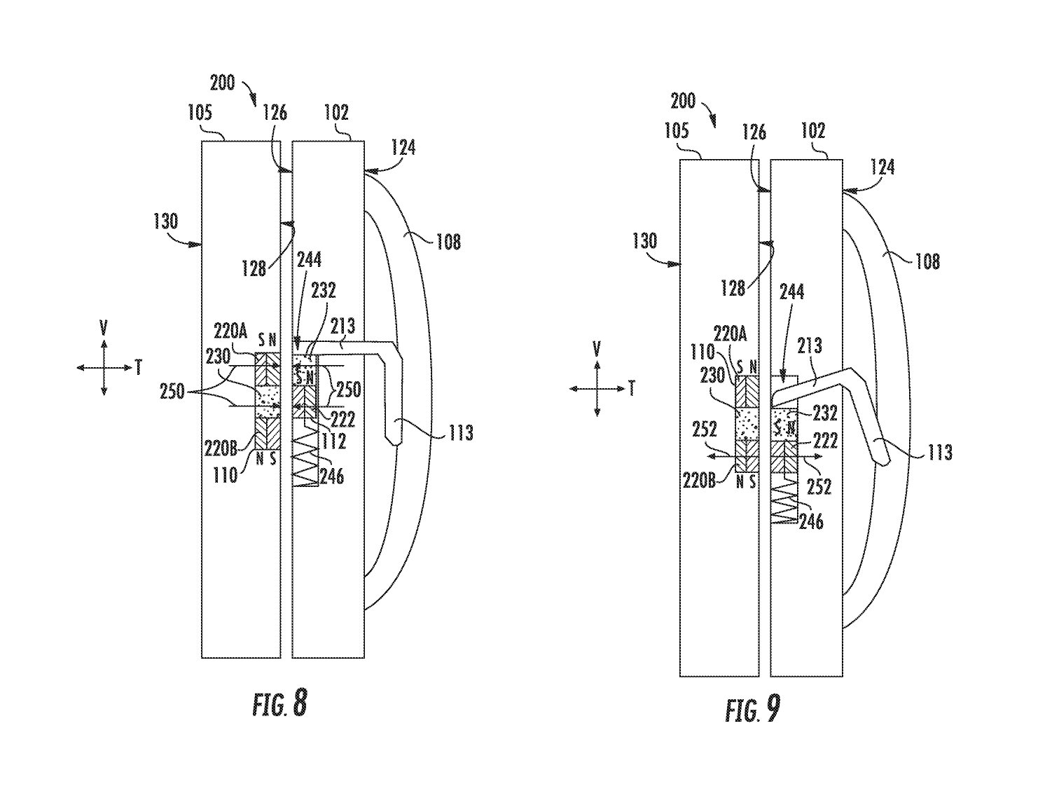

Turning now to FIGS. 8 and 9, in some embodiments, locking assembly 200 includes a first magnetic element 110 fixedly mounted within the inner door 105 between an inner surface 130 and an outer surface 128. A second magnetic element 112 is movably (e.g., slidably) mounted within the outer door 102 between an inner surface 126 and an outer surface 124. When both doors 105, 102 are provided in their respective closed positions, the first and second magnetic elements 110, 112 are thus spaced apart along the transverse direction T.

In certain embodiments, the first magnetic element 110 includes multiple vertically-aligned permanent magnets 220A, 220B. For instance, the first magnetic element 110 may include an upper permanent magnet 220A and a lower permanent magnet 220B disposed beneath the upper permanent magnet 220A. The magnetic poles of the upper and lower permanent magnets 220A, 220B may be horizontally directed in opposite directions. As an example, the north pole (e.g., first magnetic pole) of the upper permanent magnet 220A may be proximal to and directed to the outer door 102, as shown. By contrast, the north pole (e.g., first magnetic pole) of the lower permanent magnet 220B may be distal to and directed away from the outer door 102, as shown. Optionally, a ferromagnetic block 230 may be disposed between the upper and lower permanent magnets 220A, 220B along the vertical direction V. In some such embodiments, the second magnetic element 112 includes a vertically-aligned ferromagnetic block 232 and permanent magnet 222. For instance, the ferromagnetic block 232 may be disposed directly above the permanent magnet 222. The permanent magnet 222 of the second magnetic element 112 may be positioned to complement either the upper permanent magnet 220A or the lower permanent magnet 220B.

In the embodiments of FIGS. 8 and 9, the second magnetic element 112 is slidably mounted within outer door 102 between an inner surface 126 and an outer surface 124. As shown, the second magnetic element 112 is enclosed within an internal passage 244. When assembled, the second magnetic element 112 may slide such that the second magnetic element 112 can translate along the vertical direction V between a first position (FIG. 8) and a second position (FIG. 9).

As shown, in the first position, the first magnetic element 110 and the second magnetic element 112 may be aligned in magnetic engagement. Specifically, the upper permanent magnet 220A of the first magnetic element 110 may be horizontally aligned with the ferromagnetic block 232 of the second magnetic element 112. The permanent magnet 222 of the second magnetic element 112 may be horizontally aligned with the ferromagnetic block 230 of the first magnetic element 110. A magnetic pull force (indicated at arrows 250) may be formed by the magnetic engagement between the first and second magnetic elements 110, 112. Optionally, the magnetic pull force 250 may be greater than 15 pounds.

By contrast, in the second position, the ferromagnetic blocks 230, 232 of both the first and second magnetic elements 110, 112 may be horizontally aligned. Moreover, the lower permanent magnet 220B may be horizontally aligned with the permanent magnet 222 of the second magnetic element 112. The permanent magnets 220 and 222 may be in repelled pushed alignment. In other words, similar magnetic poles (e.g., the south poles) of the permanent magnets 220 and 222 may be directed toward each other, as illustrated in FIG. 9. As a result, the inner and outer doors 105, 102 may be biased away from each other by a magnetic push force (indicated at arrows 252). In specific embodiments, the magnetic push force 252 biases the outer door 102 to the open position. Advantageously, the locking assembly 200 may thus assist with separating the outer door 102 from the inner door 105.

A biasing mechanism 246, such as an elastic or resilient spring, may be provided in some such embodiments. For instance, the biasing mechanism 246 may be mounted below the second magnetic element 112 (e.g., within the internal passage 244) to generally motivate or bias the second magnetic element 112 toward the first position.

In some embodiments, the articulating arm 213 and the trigger 113 are pivotally mounted to the handle 108. Moreover, the articulating arm 213 may contact the second magnetic element 112 (e.g., as the trigger 113 is engaged or pivoted). As the trigger 113 is pivoted, the articulating arm 213 may thus force or motivate the second magnetic element 112 downward, away from the first position and toward the second position.

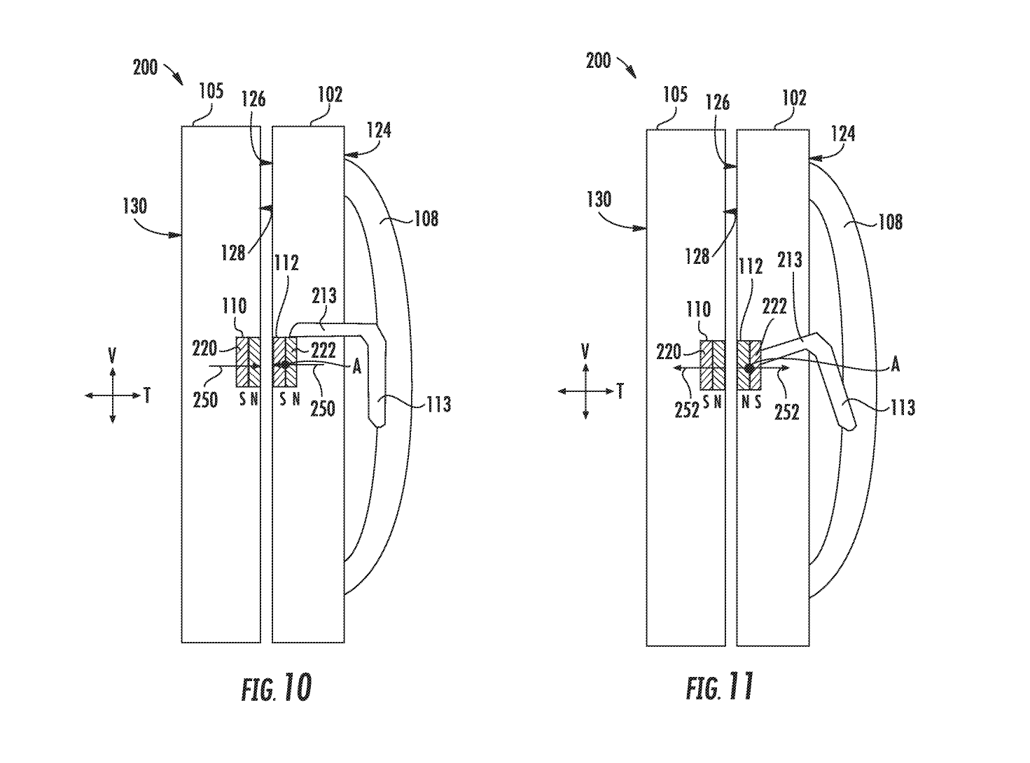

Turning now to FIGS. 10 and 11, in some embodiments, locking assembly 200 includes a first magnetic element 110 fixedly mounted within the inner door 105 between an inner surface 130 and an outer surface 128. A second magnetic element 112 is movably (e.g., pivotally) mounted within the outer door 102 between an inner surface 126 and an outer surface 124. When both doors 105, 102 are provided in their respective closed positions, the first and second magnetic elements 110, 112 are thus spaced apart along the transverse direction T.

In certain embodiments, the first magnetic element 110 includes a permanent magnet 220. The magnetic poles of the permanent magnet 220 of first magnetic element 110 may be directed horizontally. As an example, the north pole (e.g., first magnetic pole) of the permanent magnet 220 may be proximal to and directed to the outer door 102, as shown. By contrast, the south pole (e.g., the second magnetic pole) of the permanent magnet 220 may be distal to and directed away from the outer door 102, as shown. In some such embodiments, the second magnetic element 112 also includes a permanent magnet 222. For instance, the permanent magnet 222 of the second magnetic element 112 may be horizontally aligned with the permanent magnet 220 of the first magnetic element 110. Moreover, the permanent magnet 222 of the second magnetic element 112 may be directed horizontally in one or both of a first position (FIG. 10) and a second position (FIG. 11).

In the embodiments of FIGS. 10 and 11, the second magnetic element 112 is pivotally mounted within outer door 102 between an inner surface 126 and an outer surface 124. In turn, the second magnetic element 112 may define a rotation axis A. Optionally, the rotation axis A may be parallel to the lateral direction L (e.g., when inner door 105 and outer door 102 are in their respective closed positions). Additionally or alternatively, the rotation axis A may be defined through a middle or central location of the permanent magnet 222 and between the north pole and south pole thereof. When assembled, the second magnetic element 112 (e.g., the permanent magnet 222) may pivot such that the north-south poles alternate directions (e.g., rotate 180°) between the first position (FIG. 10) and the second position (FIG. 11).

As shown, in the first position, the first magnetic element 110 and the second magnetic element 112 may be aligned in magnetic engagement. Specifically, the permanent magnet 220 of the first magnetic element 110 may be horizontally aligned with the permanent magnet 222 of the second magnetic element 112. Moreover, the permanent magnet 222 of the second magnetic element 112 may complement the permanent magnet 220 of the first magnetic element 110. In turn, the first position may provide the permanent magnets 220, 222 in attracted pulled alignment. A magnetic pull force (indicated at arrows 250) may be formed by the magnetic engagement between the first and second magnetic elements 110, 112. Optionally, the magnetic pull force 250 may be greater than 15 pounds.

By contrast, in the second position, the permanent magnets 220, 222 may be in repelled pushed alignment. The permanent magnet 220 of the first magnetic element 110 may be horizontally aligned with the permanent magnet 222 of the second magnetic element 112. In other words, similar magnetic poles (e.g., the north poles) of the permanent magnets 220 and 222 may be directed toward each other, as illustrated in FIG. 11. As a result, the inner and outer doors 105, 102 may be biased away from each other by a magnetic push force (indicated at arrows 252). In specific embodiments, the magnetic push force 252 biases the outer door 102 to the open position. Advantageously, the locking assembly 200 may thus assist with separating the outer door 102 from the inner door 105.

In some embodiments, the articulating arm 213 and the trigger 113 are pivotally mounted to the handle 108. Moreover, the articulating arm 213 may contact the second magnetic element 112 (e.g., as the trigger 113 is engaged or pivoted). As the trigger 113 is pivoted, the articulating arm 213 may thus force or motivate the second magnetic element 112 to pivot about the rotation axis A, away from the first position and toward the second position.

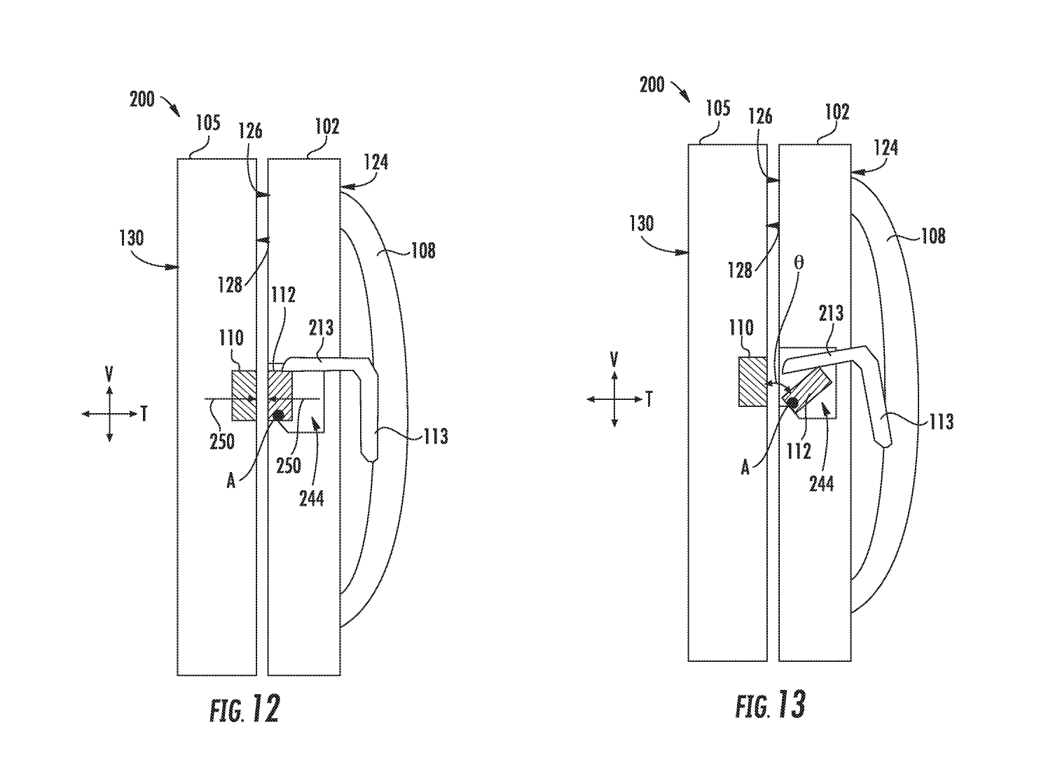

Turning to FIGS. 12 and 13, in some embodiments, locking assembly 200 includes a first magnetic element 110 fixedly mounted within the inner door 105 between an inner surface 130 and an outer surface 128. A second magnetic element 112 is movably (e.g., pivotally) mounted within the outer door 102 between an inner surface 126 and an outer surface 124. When both doors 105, 102 are provided in their respective closed positions, the first and second magnetic elements 110, 112 are thus spaced apart along the transverse direction T.

Optionally, one of the first and second magnetic elements 110, 112 may be a permanent magnet, while the other of the first and second magnetic elements 110, 112 is a ferromagnetic material (e.g., iron, nickel, cobalt, etc.). Alternatively, both the first and second magnetic elements 110, 112 may be permanent magnets.

In the embodiments of FIGS. 12 and 13, the second magnetic element 112 is pivotally mounted within outer door 102 between an inner surface 126 and an outer surface 124. As shown, the second magnetic element 112 is enclosed within an internal passage 244. The second magnetic element 112 may define a rotation axis A. Optionally, the rotation axis A may be parallel to the lateral direction L (e.g., when inner door 105 and outer door 102 are in their respective closed positions). Additionally or alternatively, the rotation axis A may be defined through a non-central (e.g., lower) location of the second magnetic element 112 relative to the vertical direction V. When assembled, the second magnetic element 112 may pivot such that the second magnetic element 112 is moved relatively close to the inner door 105 in a first position (FIG. 12) or away from the inner door 105 in a second position (FIG. 13).

As shown, in the first position, the first magnetic element 110 and the second magnetic element 112 may be aligned in magnetic engagement. For instance, the first and second magnetic elements 110, 112 may be generally aligned along a horizontal (i.e., perpendicular to the vertical direction V) plane. In other words, the first and second magnetic elements 110, 112 are horizontally aligned at the same vertical height. Moreover, the second magnetic element 112 may be proximal to the inner door 105. A magnetic pull force (indicated at arrows 250) may be formed by the magnetic engagement between the first and second magnetic elements 110, 112. Optionally, the magnetic pull force 250 may be greater than 15 pounds.

By contrast, in the second position, the second magnetic element 112 may be pivoted away from the inner door 105. Relative to the first position, the second position provides the second magnetic element 112 distal to the inner door 105. In the second position, the first magnetic element 110 and the second magnetic element 112 are at least partially offset along the vertical direction V. Moreover, a non-parallel angle θ may be formed between the second magnetic element 112 and the first magnetic element 110 relative to the vertical direction V, as illustrated in FIG. 13. In other words, the first magnetic element 110 and the second magnetic element 112 may be positioned at discrete non-parallel planes. In the second position, negligible magnetic engagement may exist between the first and second magnetic elements 110, 112 (e.g., less than one pound of force). Generally, this is understood to be less than a force holding the inner door 105 to cabinet 12 (FIG. 1). Advantageously, the locking assembly 200 may thus permit the outer door 102 to be readily separated from the inner door 105.

In some embodiments, the articulating arm 213 and the trigger 113 are pivotally mounted to the handle 108. Moreover, the articulating arm 213 may contact the second magnetic element 112 (e.g., as the trigger 113 is engaged or pivoted). As the trigger 113 is pivoted, the articulating arm 213 may thus force or motivate the second magnetic element 112 to pivot downward, about the rotation axis A, away from the first position, and toward the second position.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1-10. (canceled)

11. A refrigerator appliance comprising:
a cabinet defining a food storage chamber;
an inner door rotatably hinged to the cabinet, the inner door being movable between an open position and a closed position to permit selective access to the food storage chamber;
an outer door rotatably hinged to the inner door, the outer door being movable between an open position and a closed position; and
a locking assembly selectively securing the outer door in the closed position, the locking assembly comprising:
a first magnetic element mounted within the inner door between an opposing inner surface and outer surface of the inner door,
a second magnetic element movably mounted within the outer door between an opposing inner surface and outer surface of the outer door for selective magnetic engagement with the first magnetic element in the closed position of the outer door, the second magnetic element being movable between a first position and a second position within the outer door, and
an articulating arm coupled to the outer door in selective operative engagement with the second magnetic element to motivate the second magnetic element between the first position and the second position,
wherein a magnetic pull force greater than fifteen pounds and greater than a pull force formed between the inner door and the cabinet is formed between the first magnetic element and the second magnetic element in the closed position of the outer door when the second magnetic element is in the first position,
wherein the second magnetic element is slidable along a vertical direction between the first position and the second position.

12. (canceled)

13. (canceled)

14. The refrigerator appliance of claim 11, wherein one of the first magnetic element and second magnetic element comprises a permanent magnet and the other of the first magnetic element and second magnetic element comprises a ferromagnetic material.

15. The refrigerator appliance of claim 11, wherein the first magnetic element and the second magnetic element each comprise a permanent magnet, wherein the first position provides the permanent magnets in attracted pulled alignment, and wherein the second position provides the permanent magnets in repelled pushed alignment.

16. (canceled)

17. (canceled)

18. The refrigerator appliance of claim 11, wherein the first magnetic element comprises an upper permanent magnet, a lower permanent magnet, and a ferromagnetic block disposed between the upper and lower permanent magnets along the vertical direction, wherein the second magnet element comprises a ferromagnetic block and a permanent magnet, and wherein the ferromagnetic blocks are aligned perpendicular to the vertical direction in the second position.

19. (canceled)

20. The refrigerator appliance of claim 11, further comprising a handle mounted to the outer door, and a trigger operatively coupled to the articulating arm to direct movement thereof.

21. A refrigerator appliance comprising:
a cabinet defining a food storage chamber;
an inner door rotatably hinged to the cabinet, the inner door being movable between an open position and a closed position to permit selective access to the food storage chamber;
an outer door rotatably hinged to the inner door, the outer door being movable between an open position and a closed position;
a locking assembly selectively securing the outer door in the closed position, the locking assembly comprising:
a first magnetic element mounted within the inner door between an opposing inner surface and outer surface of the inner door,
a second magnetic element movably mounted within the outer door between an opposing inner surface and outer surface of the outer door for selective magnetic engagement with the first magnetic element in the closed position of the outer door, the second magnetic element being movable between a first position and a second position within the outer door, and
an articulating arm coupled to the outer door in selective operative engagement with the second magnetic element to motivate the second magnetic element between the first position and the second position;
a handle mounted on an outer surface of the outer door to selectively pull the outer door to the open position thereof and the inner door to the open position thereof; and
a trigger movably mounted to the handle, the trigger extending through the outer door and operatively coupled to the articulating arm to direct movement of the second magnetic element,
wherein a magnetic pull force greater than fifteen pounds and greater than a pull force formed between the inner door and the cabinet is formed between the first magnetic element and the second magnetic element in the closed position of the outer door when the second magnetic element is in the first position, and
wherein the second magnetic element is slidable along a vertical direction between the first position and the second position.

22. (canceled)

23. (canceled)

24. The refrigerator appliance of claim 21, wherein one of the first magnetic element and second magnetic element comprises a permanent magnet and the other of the first magnetic element and second magnetic element comprises a ferromagnetic material.

25. The refrigerator appliance of claim 21, wherein the first magnetic element and the second magnetic element each comprise a permanent magnet, wherein the first position provides the permanent magnets in attracted pulled alignment, and wherein the second position provides the permanent magnets in repelled pushed alignment.

26. (canceled)

27. (canceled)

28. The refrigerator appliance of claim 21, wherein the first magnetic element comprises an upper permanent magnet, a lower permanent magnet, and a ferromagnetic block disposed between the upper and lower permanent magnets along the vertical direction, wherein the second magnet element comprises a ferromagnetic block and a permanent magnet, and wherein the ferromagnetic blocks are aligned perpendicular to the vertical direction in the second position.

29. A refrigerator appliance comprising:
a cabinet defining a food storage chamber;
an inner door rotatably hinged to the cabinet, the inner door being movable between an open position and a closed position to permit selective access to the food storage chamber;
an outer door rotatably hinged to the inner door, the outer door being movable between an open position and a closed position;
a locking assembly selectively securing the outer door in the closed position, the locking assembly comprising:
a first magnetic element mounted within the inner door between an opposing inner surface and outer surface of the inner door,
a second magnetic element movably mounted within the outer door between an opposing inner surface and outer surface of the outer door for selective magnetic engagement with the first magnetic element in the closed position of the outer door, the second magnetic element being movable between a first position and a second position within the outer door, and
an articulating arm coupled to the outer door in selective operative engagement with the second magnetic element to motivate the second magnetic element between the first position and the second position, the first position permitting the opening of the outer door and the inner door together, the second position permitting the opening of the outer door separate from the inner door;
a handle mounted on an outer surface of the outer door to selectively pull the outer door to the open position thereof and the inner door to the open position thereof; and
a trigger movably mounted to the handle, the trigger extending through the outer door and operatively coupled to the articulating arm to direct movement of the second magnetic element,
wherein a magnetic pull force greater than fifteen pounds and greater than a pull force formed between the inner door and the cabinet is formed between the first magnetic element and the second magnetic element in the closed position of the outer door when the second magnetic element is in the first position,
wherein the second magnetic element is slidable along a vertical direction between the first position and the second position,
wherein the first magnetic element comprises an upper permanent magnet, a lower permanent magnet, and a ferromagnetic block disposed between the upper and lower permanent magnets along the vertical direction,
wherein the second magnet element comprises a ferromagnetic block and a permanent magnet, and
wherein the ferromagnetic blocks are aligned perpendicular to the vertical direction in the second position.
